(19) United States
(12) Patent Application Publication
(10) Pub. No.: US 2009/0316676 A1
(43) Pub. Date: Dec. 24, 2009

(54) Method and Apparatus for Coupled Sounding

(75) Inventors: Troels Emil Kolding, Klarup (DK); Klaus Ingemann Pedersen, Aalborg (DK); Timo Erkki Lunttila, Espoo (FI); Mihai Horatiu Enescu, Espoo (FI); Chun Yan Gao, Beijing (TW)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignees: NOKIA CORPORATION, Espoo (FI); NOKIA SIEMENS NETWORKS OY, Espoo (FI)

(21) Appl. No.: 12/141,253

(22) Filed: Jun. 18, 2008

(51) Int. Cl. H04J 3/00

(52) U.S. Cl. 370/345

(57) ABSTRACT

In accordance with an example embodiment of the present invention, an apparatus, comprising a processor configured to derive a time period; and a transmitter configured to transmit a first signal and a second signal to a network element, wherein the second signal is coupled to the first signal in a predetermined way within the time period, is disclosed.

### RELATED APPLICATIONS

This application relates to U.S. application Ser. No. 11/840,830, titled METHOD AND APPARATUS FOR PROVIDING CHANNEL FEEDBACK INFORMATION, filed on 17 Aug. 2007, which is hereby incorporated by reference in its entirety.

### TECHNICAL FIELD

The present application relates generally to wireless networks.

### BACKGROUND

Wireless communications systems typically include one or more communications stations, generally called base stations, each communicating with its subscribers, also called remote terminals. Communication from the remote terminal to the base station is typically called uplink (UL) and communication from the base station to the remote terminal is typically called downlink (DL).

In time division duplex (TDD) systems, uplink and downlink communications with a particular remote terminal occur at the same frequency, but at different time slots. In frequency division duplex (FDD) systems, uplink and downlink communications with a particular remote terminal occur at different frequencies and may or may not occur at the same time.

For TDD systems, since both the uplink and the downlink share same frequency, the measurements in one end (e.g. uplink) may be used to assess the performance also in the other end (e.g. downlink). However, this reciprocity is very hard to achieve in practice because the interference level in the uplink and the downlink is generally different and thus a Signal to Interference-plus-Noise Ratio (SINR) based report in one end cannot be used for radio link control in the other end without compensation.

3GPP (third generation partnership project) is standardizing the long term evolution (LTE) of the radio access technology, also called Evolved UMTS (universal mobile telecommunications system) Terrestrial Radio Access Network (E-UTRAN).

LTE makes use of reference signals for various purposes, such as for channel estimation in the receiver, frequency estimation, and timing estimation. Currently in LTE, three types of downlink reference signals are defined: Cell-specific reference signals, associated with non-MBSFN (non-multicast broadcast single frequency network) transmission; MBSFN (multicast broadcast single frequency network) reference signals, associated with MBSFN transmission; and UE (User Equipment)-specific reference signals. In LTE, two types of uplink reference signals are supported: demodulation reference signal, associated with transmission of uplink data and/or control signaling; and sounding reference signal, not associated with uplink data transmission. A sounding reference signal is used mainly for channel quality determination if channel dependent scheduling is used.

A terminal feeds back downlink channel information, such as channel quality indication (CQI) to the e-NodeB. This assists a base station (e.g., an e-NodeB in LTE) to know the wireless channel variation, which facilitates making appropriate decision of the scheduling and link adaptation.

A variety of CQI report mechanisms may be used, such as a Best-M CQI report, a threshold-based CQI report, and a select-S CQI report. In Best-M mechanism the terminal selects M (M<N) best subbands, where N is the number of subbands in the total bandwidth, and feeds back the CQIs of the M best subbands to the e-NodeB. In threshold-based mechanism the terminal selects and sends the CQI feedback based on an absolute threshold. In select-S mechanism the terminal monitors a subset (denoted e.g., by S) of the N subbands and reports the CQI feedback for the set S rather than for the full set of subbands. The terminal may provide Best-M reporting of the best M subbands within the set S.

The CQI report and uplink reference signals are transmitted independently. 3GPP technical specification TS36.213 version 8.2.0 specifies that some Sounding Reference Symbol (SRS) parameters comprising frequency hopping and bandwidth of SRS transmission are UE specific and semi-statically configurable by higher layer signaling.

### SUMMARY

Various aspects of the invention are set out in the claims.

In accordance with an example embodiment of the present invention, an apparatus, comprising a processor configured to derive a time period; and a transmitter configured to transmit a first signal and a second signal to a network element, wherein the second signal is coupled to the first signal in a predetermined way within the time period, is disclosed.

In accordance with another example embodiment of the present invention, a method, comprising deriving a time period; transmitting a first signal to a network element; generating a second signal, the second signal being coupled to the first signal in a predetermined way within the time period; and transmitting the second signal to the network element, is disclosed.

In accordance with another example embodiment of the present invention, an apparatus, comprising a processor configured to determine a time period; and a receiver configured to receive a first signal and a second signal, wherein the receiver is configured to receive the second signal based at least in part on the received first signal and within the determined time period, is disclosed.

In accordance with another example embodiment of the present invention, a method, comprising determining a time period; receiving a first signal; and receiving a second signal based at least in part on the received first signal and within the determined time period, is disclosed.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 shows a simplified block diagram of various electronic devices that are suitable for use in practicing example embodiments of this invention;

FIG. 2 is a flowchart of an example method for coupled sounding according to an embodiment of the invention;

FIG. 3 is a flowchart of another example method for coupled sounding according to an embodiment of the invention;

FIG. 4 is a timing diagram for coupled sounding according to an example embodiment of the invention;

FIG. 5 is a diagram of an example uplink sounding according to an example embodiment of the invention; and

FIG. 6 is a diagram of another example uplink sounding according to another example embodiment of the invention.

### DETAILED DESCRIPTION OF THE DRAWINGS

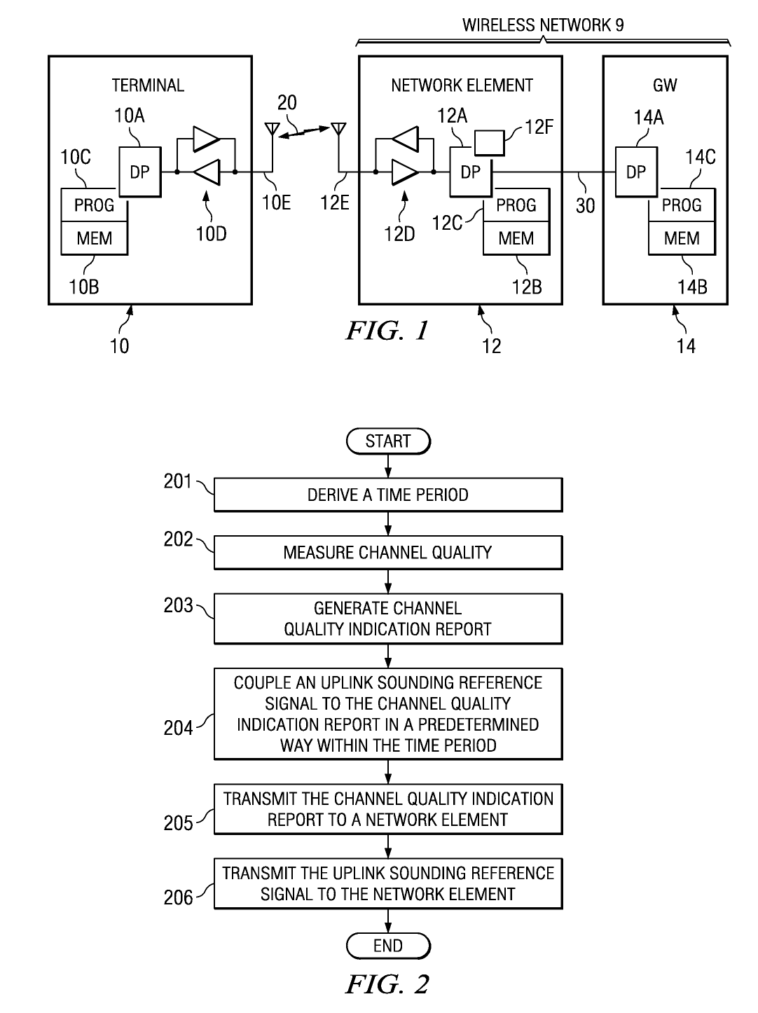

An example embodiment of the present invention and its potential advantages are best understood by referring to FIGS. 1 through 6 of the drawings.

FIG. 1 shows a simplified block diagram of various electronic devices that are suitable for use in practicing example embodiments of this invention. In FIG. 1 a wireless network 9 is adapted for communication between a terminal 10 and a network element 12. Network element 12 may be, for example, a wireless access node, such as a base station or particularly an e-NodeB for a LTE system and/or the like. The network 9 may comprise another network element 14, for example, a gateway GW, a serving mobility entity MME, a radio network controller RNC and/or the like. In an embodiment, the terminal 10 comprises a data processor (DP) 10A, a memory (MEM) 10B that stores a program (PROG) 10C, and a suitable radio frequency (RF) transceiver 10D coupled to one or more antennas 10E (one shown). Transceiver 10D and antenna 10E may be used for bidirectional wireless communications over one or more wireless links 20 with the network element 12. The data processor 10A may comprise an estimator that uses a reference signal to estimate timing, frequency, channel and/or the like. The estimator has an operating range over which it is capable of making such an estimate of the timing, frequency, channel and/or the like. The wireless links 20 may be any of various channels including for example physical downlink control channel PDCCH. For the case of multiple input/multiple output transmissions of the reference signals from the network element, the terminal 10 may receive the reference signals over more than one antenna 10E if desired.

The network element 12 also comprises a DP 12A, a MEM 12B that stores a PROG 12C, and a suitable RF transceiver 12D coupled to one or more antennas 12E (one shown). Antenna 12E may interface to the transceiver 12D via respective antenna ports. The DP 12A may also comprise an estimator that uses an uplink reference signal (e.g. reference sounding signals, training sequences, pilots, reference symbols etc.) to estimate channel state information. The network element 12 may be coupled via a data path 30 e.g., Iub or S1 interface, to the serving or other GW/MME/RNC 14. The GW/MME/RNC 14 may include a DP 14A, a MEM 14B that stores a PROG 14C, and a suitable modem and/or transceiver (not shown) for communication with the network element 12 over the data path 30.

Network element 12 may also comprise a scheduler 12F that schedules the various terminals under its control for the various UL and DL radio resources. After the network element makes scheduling grants decision on the terminals' UL and/or DL radio resources, it sends messages to the terminals with the scheduling grants. In an example embodiment, grants for multiple terminals are sent in one message. In LTE these grants are sent over particular channels such as the PDCCH. Generally, the network element 12 of an LTE system is fairly autonomous in its scheduling and does not coordinate with the GW/MME 14 except during handover of one of its terminals to another network element.

At least one of the PROGs 10C, 12C and 14C is assumed to comprise program instructions that, when executed by the associated DP, enable the electronic device to operate in accordance with the example embodiments of this invention, as detailed above. Inherent in each of the DPs 10A, 12A, and 14A is a clock to enable synchronism among the various apparatus for transmissions and receptions. The scheduling grants and the granted resources are time dependent. By aid of the clock the transmissions and receptions of the various apparatus occur within the appropriate time intervals and slots required. The transceivers 10D, 12D may include both transmitter and receiver, and inherent in each is a modulator/demodulator commonly known as a modem. The DPs 12A, 14A also are assumed to each include a modem to facilitate communication over the (hardwire) link 30 between the network element 12 and the GW 14.

The PROGs 10C, 12C, 14C may be embodied in software, firmware and/or hardware, as appropriate. In general, the example embodiments of the invention may be implemented by computer software stored in the MEM 10B and executable by the DP 10A of the terminal 10. If desired, the example embodiments of the invention may be implemented by computer software stored in the MEM 12B and executable by the DP 12A of the e-NodeB 12. If desired, the example embodiments of the invention may be implemented by hardware, or by a combination of software and/or firmware and/or hardware in any or all of the devices shown.

In general, the various embodiments of the terminal 10 may include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, GPS devices having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory, removable memory and/or the like. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

For the purpose of explanation, downlink channel quality indication and uplink sounding reference signal are used as examples in the following description to provide a thorough understanding of the invention. However, embodiments of the invention are not limited to these details; it may be practiced with an equivalent arrangement.

FIG. 2 is a flowchart of an example method for coupled sounding according to an embodiment of the invention. In an example embodiment, the method of FIG. 2 is performed by a terminal, for example terminal 10 of FIG. 1.

At block 201, a time period is derived. In an example embodiment, the time period may be hard-coded, or be configured via higher layer signaling, e.g. RRC signaling. The time period may be defined by a time window called a window of opportunity in below description, or a timer which has start and expiry property, or something similar. The window of opportunity may be determined by two timing factors, a start time and an end time, which define the valid time span of the window of opportunity. At block 202, channel quality measurement for a downlink is performed. In an example embodiment, channel quality measurement relates to or indicates the measurement of the communication quality of radio links, for example by measuring the SINR of a pilot signal transmitted by a network element. At block 203, a channel quality indication report, e.g. a CQI report, is generated. When generating the channel quality indication report, in an example embodiment, at least one subband (referred as “selected subbands” hereafter) of the total bandwidth is used.

At block 204, an uplink sounding reference signal may be coupled to the channel quality indication report in a predetermined way, e.g. the bandwidth of the uplink sounding reference signal is tied to the bandwidth of the channel quality indication report, within the derived time period. In an example embodiment, the uplink sounding reference signal is the sounding reference signal as specified in the LTE technical specification 36.211v820 section 5.5. Examples of coupling the uplink sounding reference signal to the channel quality indication report will be described hereafter. At block 205, the channel quality indication report is transmitted to a network element, for example network element 12 of FIG. 1. If desired, the channel quality indication report may be sent by sending a SINR or Transport Block Size (TBS) indication for the selected subbands. If SINR or TBS indication is used, the average SINR over the bands may be used as a reference. At block 206, the coupled uplink sounding reference signal is transmitted to the network element.

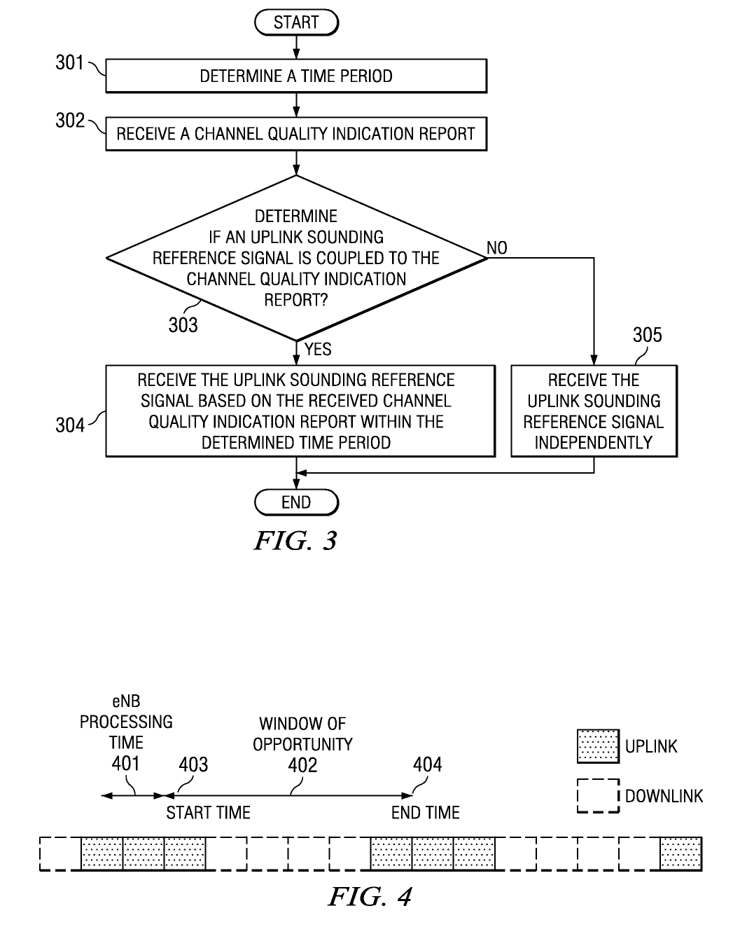

FIG. 3 is a flowchart of another example method for coupled sounding according to an embodiment of the invention. In an example embodiment, the method of FIG. 3 is performed by a network element, for example network element 12 of FIG. 1.

At block 301, a time period is determined. In an example embodiment, the time period may be hard-coded and/or specified in the technical specifications; or be determined by the network element for example based on the network element's processing capability and/or the validity of a channel quality indication report; and/or the like. At block 302, a channel quality indication report is received. In an example embodiment, the channel quality indication report is received from a terminal, for example terminal 10 of FIG. 1. At block 303, a determination is made as to whether an uplink sounding reference signal is coupled to the channel quality indication report. In an example embodiment, this determination is made by the network element's own estimation, or by an explicit indication sent from the terminal. If it is determined that the uplink sounding reference signal is coupled to the channel quality indication report, then at block 304 the uplink sounding reference signal is received. In an example embodiment, the uplink sounding reference signal is received from the terminal based at least in part on the received channel quality indication report within the determined time period. If it is determined that the uplink sounding reference signal is not coupled to the channel quality indication report, then at block 305 the uplink sounding reference signal is received independently of the received channel quality indication report.

In an example embodiment, the network element 12 may use the channel quality indication report and the uplink sounding reference signal to evaluate channel status information of downlink channel and uplink channel. The downlink channel status information and the uplink channel status information are helpful for the network element to make scheduling decisions.

In an example embodiment, the above mentioned time period and the predetermined way of coupling are known to the side who sends the channel quality indication report and the uplink sounding reference signal and also to the side who receives the channel quality indication report and the uplink sounding reference signal. In an example embodiment, the two sides are terminal 10 and network element 12. The network element 12 will be able to identify the bandwidth boundaries for the uplink sounding reference signal by estimating the last received channel quality indication report. If there is a reception error, network element 12 may be able to blindly search for the uplink sounding reference signal, or it may wait until next channel quality indication report/uplink sounding reference signal is received, e.g., from the terminal 10.

FIG. 4 is a timing diagram for coupled sounding according to an example embodiment of the invention. In an example embodiment, since the uplink sounding reference signal is used for a different purpose than the channel quality indication report and a channel quality indication report only has limited validity in time, a “window of opportunity” (shown as 402) is provided. In an example embodiment, in the window of opportunity the terminal may use the channel quality indication report for defining its sounding bandwidth.

In an example embodiment, start time 403 defines the start of the window of opportunity 402. In an example embodiment, processing time 401 of a network element, for example network element 12 of FIG. 1, indicates the time that the network element needs to process channel quality indication report, for example the channel quality indication report received at block 302 of FIG. 3. The network element reads and understands the channel quality indication report before it may know where the coupled uplink sounding reference signal will take place. Hence, processing time 401 is considered when defining the window of opportunity. The processing time 401 may be outside the window of opportunity. In such a case, when the terminal transmits uplink sounding reference signal it compresses its sounding bandwidth from the channel quality indication report after the processing time 401 has passed. An alternative solution to make the effective processing time small would be for the network element to delay its decoding of the uplink sounding reference signals until the channel quality indication report is decoded thereby delaying the reception and storing of earlier received signals.

In an example embodiment, end time 404 defines the end of the window of opportunity. Here, the validity of the channel quality indication report in time domain may be considered. The exact validity time may depend on several factors, such as, mobility of the terminal and/or the like. Dependent on the mobility speed of the terminal this value may be a few milliseconds, for example for a terminal with high mobility, up to tens of milliseconds, for example for a terminal with low mobility.

The start time 403 of the window of opportunity 402 may be hard-coded and/or specified in the technical specifications or may be configured by higher layer signalling. The end time 404 may be hard-coded and/or specified in the technical specifications or may be configured at call setup and possibly changed semi-statically via higher layer signalling.

If desired, there could be some associated rules to terminate the window of opportunity when the network element indicates that it lost its channel quality indication report. For example, if a terminal sends a channel quality indication report and the network element after the processing time uses a different allocation in downlink, the terminal may be pre-configured, e.g. specified behaviour in specifications, to stop coupling uplink sounding reference signal to the channel quality indication report. Selecting resources different from the channel quality indication report may also be based on other aspects. So use of other resources does not always mean that channel quality indication report was indeed lost. In an example embodiment, both the terminal and the network element have common understanding of the mechanisms for defining the window of opportunity. Thus, both of them know when the coupling is terminated.

In an example embodiment, using coupled uplink sounding reference signal may mean that the terminal 10 will send a “lean” uplink sounding reference signal, for example at block 206 of FIG. 2. In such an embodiment, the terminal uses a subset of the bandwidth that it is normally requested to use, when it is in the window of opportunity, for example at block 204 of FIG. 2. The subset selection may be based on the channel quality indication report's selected subbands. Hence, coupled sounding occupies less bandwidth than non-coupled sounding. It should be noted that the coupled sounding only limits the sounding bandwidth compared to the configured bandwidth for the effected terminal. Thus there is no collision between sounding signals of different terminals. For example, when a terminal is configured to sound the complete uplink bandwidth, the scheduler reserves space for the sounding signal across the complete bandwidth so that there is no collision with other terminals. However, when the channel quality indication indicates only part of the band is interesting, the terminal may safely concentrate its transmission power to a sub-bandwidth as described above. In an example embodiment, the terminal may preserve a power spectral density, not boost the transmission power to save operating power, and thus extend the lifetime of the battery. In an example embodiment, the terminal may maintain a target power spectral density of the uplink sounding reference signal in a predefined way, e.g., controlled by power control. It may ensure minimum bandwidth of the uplink sounding reference signal if the power is limited for the uplink sounding reference signal. In such an example embodiment, the space is still reserved across the complete bandwidth. However, the terminal does not transmit sounding signal in the remaining bands. If a terminal has a certain sounding bandwidth configured, then in an example embodiment the coupled sounding does not define sounding boundaries beyond the configured limits, for example at block 204 of FIG. 2. The coupled sounding may allow the network element to allocate a wider sounding bandwidth than what may be accurately sustained by an available terminal link budget. The terminal link budget may be, for example, available transmission power of a terminal. Hence, sounding becomes more effective for the same transmission power budget.

Referring to FIG. 2, an example of channel quality indication report using the Best-M CQI report is provided. The example may also apply for other CQI report methods that consider limited or selected parts of a total bandwidth, e.g. the threshold-based CQI report, the select-S CQI report, and/or the like. The terminal 10 selects its best M subbands for reporting CQI. In an example embodiment, the selection of best M subbands may be based on the desired signal only and not interference. The selected M by frequency ordered subbands may be identified by a vector {SB1, SB2, . . . , SBM}, where SB1 and SBM mark the “outer” subbands. The terminal 10 may limit its uplink sounding reference signal to the bandwidth [SB1-SBM] identified in the CQI report.

Some modifications compared to the bandwidth [SB1-SBM] range may be desired. In an example embodiment, it may be desirable to sound a certain minimum bandwidth in uplink. In such a case the terminal may determine its sounding bandwidth, for example, by using a centered approach from the [SB1-SBM] region.

In an example embodiment, it may be desirable to sound a certain maximum bandwidth. In such a case the terminal may select a subset of [SB1-SBM]. Some distribution rules may be desired for different terminals so that not all uplink sounding reference signals are in the same region. The distribution rules may be signalled, for example from a network element, to the terminals.

In an example embodiment, when the maximum bandwidth is defined in conjunction with frequency hopping patterns, it may be used to further improve the integration between the CQI and the uplink sounding reference signal.

In an example embodiment, if the uplink sounding reference signal is transmitted using Constant Amplitude Zero Auto-Correlation (CAZAC) code, then the sounding bandwidth may be defined to be more “fixed” compared to what is suggested by the CQI report measurement. The terminal may “round” its sounding range to the desired boundaries for the CAZAC code. For example, the terminal may select the nearest CAZAC boundary that fits most closely to the CQI report bandwidth, and include the bandwidth region that the CAZAC boundary covers (referred as CAZAC region hereafter) to its uplink sounding reference signal's bandwidth. If the CQI report almost spans a certain part of the CAZAC region, then the CAZAC region may be included in the uplink sounding reference signal's bandwidth. If the CQI report only covers a minor part of the CAZAC region, e.g. less than half of the CAZAC region, then the terminal may not include the CAZAC region in the uplink sounding reference signal's bandwidth. In another example embodiment, the CAZAC rounding may be based on spectral power requirements. For example, the terminal may increase its sounding bandwidth as long as the power density, e.g. calculated as a ratio of sounding bandwidth and CQI report bandwidth, does not exceed a threshold. In such a case, if the CQI report bandwidth is wide, the terminal may round its sounding bandwidth to a wider CAZAC region.

In below example embodiments, x represents a subband that is included in best-M subbands, y represents a subband that is included in sounding subbands, and 0 represents a subband that is not included in best-M subbands or sounding subbands.

To decide the sounding bandwidth based on the CQI report bandwidth, the bandwidth of the CQI report is mapped to the sounding bandwidth correspondingly. If the CQI report band is 0, then the sounding band is labelled as 0; otherwise, the sounding band is labelled as y. The coupled sounding bandwidth is determined based at least in part on the labelled sounding bandwidth.

In an example embodiment, if the CQI report bandwidth is selected as: 0x000xxx00, using a similar method as described above, the label of the sounding bandwidth is 0y000yyy00. Thus, the coupled sounding bandwidth may be selected as: 0y000yyy00.

In an example embodiment, if the CQI report bandwidth is selected as: 0x000xxx00 and the terminal has sufficient power and has only one opportunity to send sounding within the window of opportunity. Using a similar method as described above, the labelled sounding bandwidth is 0y000yyy00. Because the terminal has sufficient power and has only one opportunity to send sounding within the window of opportunity, the 3^{rd} to 5^{th} sounding band are modified to y. So the coupled sounding bandwidth may be selected as 0yyyyyyy00.

In an example embodiment, if the CQI report bandwidth is selected as: 0x000xxx00, and the terminal is configured for hopping and it has 4 opportunities to send sounding within the window of opportunity. The labelled sounding bandwidth is 0y000yyy00. The 4 “y” labelled bands may be transmitted using hopping by the 4 opportunities respectively, thus the coupled sounding bandwidth for the 4 opportunities may be selected as:
1^{st} opportunity: 0y00000000;
2^{nd} opportunity: 00000y0000;
3^{rd} opportunity: 000000y000; and
4^{th} opportunity: 0000000y00.

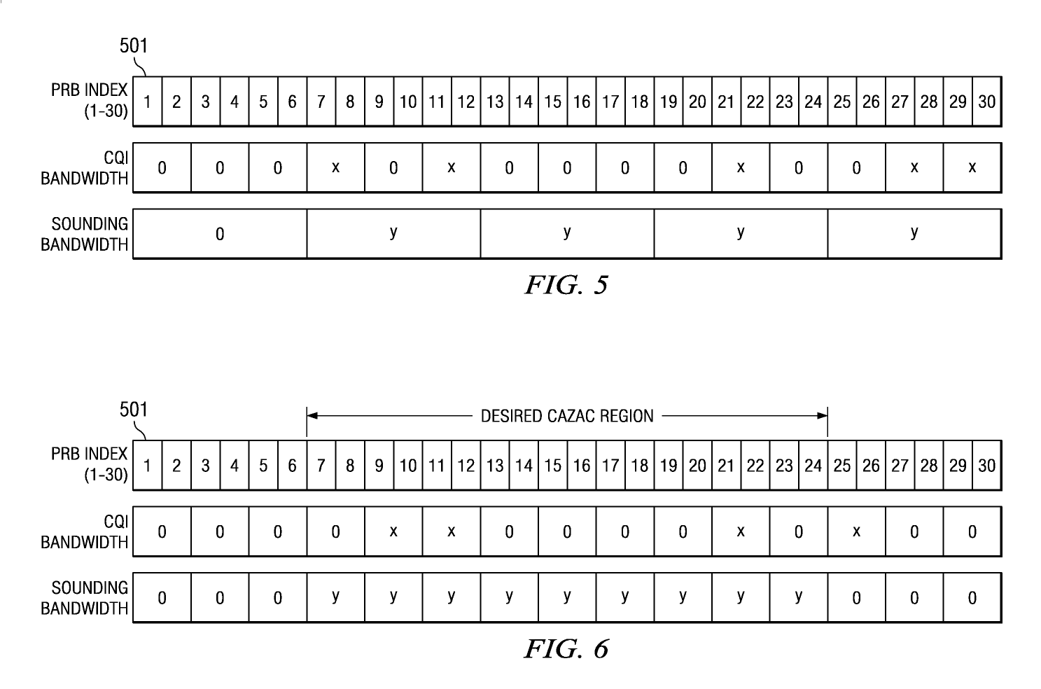

FIG. 5 is a diagram of an example uplink sounding according to an example embodiment of the invention. It illustrates an example of how coupled sounding is handled when the granularity of the sounding bandwidth and the CQI report bandwidth are different. Block 501 is an example of one PRB (Physical Resource Block). In the example, the PRBs are indexed from 1 to 30. In the illustrated example, the granularity of the CQI report bandwidth is 2 PRBs and the granularity of the sounding bandwidth is 6 PRBs.

In an example embodiment, in order to decide the sounding bandwidth based on the CQI report bandwidth, the CQI report bandwidth is mapped to the sounding bandwidth with corresponding PRB index order. If all CQI report bands are 0 within a sounding band, then the sounding band is labelled as 0; otherwise, the sounding band is labelled as y. The coupled sounding bandwidth is determined based at least in part on the labelled sounding bandwidth.

In the example of FIG. 5, the CQI report bandwidth is selected as: 000x0x0000x00xx for the 30 PRBs and it is desirable for the terminal to have a consecutive frequency area for uplink sounding. The 1^{st} to 3^{rd} CQI report bands (indexed as PRB1-6) are mapped to the 1^{st} sounding band as 000, then the 1^{st} sounding band is labelled as 0; the 2^{nd} sounding band is labelled as y; the 3^{rd} sounding band is labelled as 0; the 4^{th} sounding band is labelled as y; and the 5^{th} sounding band is labelled as y. Then, the labelled sounding bandwidth is 0y0yy. Because it is desirable that the terminal has a consecutive frequency area for uplink sounding, the 3^{rd} sounding band is modified to y to keep the frequency area consecutive. So the coupled sounding bandwidth may be selected as 0yyyy for the 30 PRBs.

FIG. 6 is a diagram of another example uplink sounding according to another example embodiment of the invention. FIG. 6 illustrates an example of how coupled sounding is handled when the desired CAZAC region and the CQI report bandwidth are not fully aligned. Block 501 is an example of one PRB. In the example, the PRBs are indexed from 1 to 30. The granularity of the CQI report bandwidth is 2 PRBs and the granularity of the sounding bandwidth is 2 PRBs.

In the illustrated example, the CQI report bandwidth is selected as: 0000xx0000x0x00 for the 30 PRBs and the PRBs indexed from 7 to 24 define the desired CAZAC region. Using a similar method as described with reference to FIG. 5, the sounding bandwidth is labelled as 0000yy0000y0y00. To round the sounding bandwidth to the desired CAZAC region, the sounding bands mapped with PRBs 7-24 are modified to y and the sounding bands out of the CAZAC region are modified to 0. Therefore, the coupled sounding bandwidth may be selected as 000yyyyyyyyy000 for the 30 PRBs.

Without in any way limiting the scope, interpretation, or application of the claims appearing below, it is possible that a technical advantage of one or more of the example embodiments disclosed herein may be terminal transmission power saving. Another possible technical advantage of one or more example embodiments may be improved performance and throughput of a communication system. Another possible technical advantage of one or more example embodiments may be lower interference on sounding signals, thus better sounding signal quality and/or lower sounding signal transmission power.

Embodiments of the present invention may be implemented in software, hardware, application logic or a combination of software, hardware and application logic. The software, application logic and/or hardware may reside on terminal, or network element. If desired, part of the software, application logic and/or hardware may reside on terminal, part of the software, application logic and/or hardware may reside on network element. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a processor configured to derive a time period; and
a transmitter configured to transmit a first signal and a second signal to a network element, wherein the second signal is coupled to the first signal in a predetermined way within the time period.

2. An apparatus according to claim 1, wherein the second signal occupies less bandwidth than a signal that is not coupled to the first signal.

3. An apparatus according to claim 1, wherein the first signal comprises a channel quality for a downlink and the second signal comprises a sounding signal in an uplink.

4. An apparatus according to claim 1, wherein the time period comprises a start time and an end time.

5. An apparatus according to claim 1, wherein the time period is configured via higher layer signaling.

6. An apparatus according to claim 1, wherein the predetermined way is configured via higher layer signaling.

7. An apparatus according to claim 1, wherein the predetermined way comprises tying the bandwidth of the second signal to the bandwidth of the first signal.

8. A method, comprising:
deriving a time period;
transmitting a first signal to a network element;
generating a second signal, the second signal being coupled to the first signal in a predetermined way within the time period; and
transmitting the second signal to the network element.

9. A method according to claim 8, wherein the second signal occupies less bandwidth than a signal that is not coupled to the first signal.

10. A method according to claim 8, wherein the first signal comprises a channel quality for a downlink and the second signal comprises a sounding signal in an uplink.

11. A method according to claim 8, wherein the time period is configured via higher layer signal.

12. A method according to claim 8, wherein the time period comprises a start time and an end time.

13. A method according to claim 8, wherein the predetermined way is configured via higher layer signaling.

14. A method according to claim 8, wherein the predetermined way comprises tying the bandwidth of the second signal to the bandwidth of the first signal.

15. A computer program product comprising a computer-readable medium bearing computer program code embodied therein for use with a computer, the computer program code comprising:
code for deriving a time period;
code for transmitting a first signal to a network element;
code for generating a second signal, the second signal being coupled to the first signal in a predetermined way within the time period; and
code for transmitting the second signal to the network element.

16. A computer program product according to claim 15, wherein the second signal occupies less bandwidth than a signal that is not coupled to the first signal.

17. An apparatus, comprising:
a processor configured to determine a time period; and
a receiver configured to receive a first signal and a second signal, wherein the receiver is configured to receive the second signal based at least in part on the received first signal and within the determined time period.

18. An apparatus according to claim 17, wherein the processor is further configured to determine whether the second signal is coupled to the first signal.

19. An apparatus according to claim 17, wherein the first signal comprises a channel quality for a downlink and the second signal comprises a sounding signal in an uplink.

20. An apparatus according to claim 17, wherein the time period is configured via higher layer signaling.

21. An apparatus according to claim 17, wherein the time period comprises a start time and an end time.

22. An apparatus according to claim 18, wherein the receiver is configured to receive the second signal based at least in part on the received first signal and within the determined time period, in response to a determination that the second signal is coupled to the first signal.

23. An apparatus according to claim 18, wherein the receiver is further configured to receive the second signal independently of the received first signal in response to a determination that the second signal is not coupled to the first signal.

24. A method, comprising:
determining a time period;
receiving a first signal; and
receiving a second signal based at least in part on the received first signal and within the determined time period.

25. A method according to claim 24, further comprising determining whether the second signal is coupled to the first signal.

26. A method according to claim 25, wherein said receiving said second signal comprises receiving said second signal based at least in part on the received first signal and within the determined time period, in response to a determination that the second signal is coupled to the first signal.

27. A method according to claim 24, wherein the first signal comprises a channel quality for a downlink and the second signal comprises a sounding signal in an uplink.

28. A method according to claim 24, wherein the time period comprises a start time and an end time.

29. A method according to claim 24, wherein the time period is configured via higher layer signal.

30. A computer program product comprising a computer-readable medium bearing computer program code embodied therein for use with a computer, the computer program code comprising:
code for determining a time period;
code for receiving a first signal; and
code for receiving a second signal based at least in part on the received first signal and within the determined time period.

31. A computer program product according to claim 30, wherein the first signal comprises a channel quality for a downlink and the second signal comprises a sounding signal in an uplink.
